(19) United States
(12) Patent Application Publication
(10) Pub. No.: US 2010/0127544 A1
(43) Pub. Date: May 27, 2010

(54) LOCKABLE RECLINING ADJUSTMENT DEVICE TO CONTROL THE TILTING OF THE SEAT FRAME OF A MANUAL WHEELCHAIR

(75) Inventor: Abdul Samad Panchbhaya, Mississauga (CA)

Correspondence Address: MARKS & CLERK, P.O. BOX 957, STATION B, OTTAWA, ON, K1P 5S7, CA

(73) Assignee: FUTURE MOBILITY HEALTHCARE INC., Mississauga (CA)

(21) Appl. No.: 12/277,545

(22) Filed: Nov. 25, 2008

(51) Int. Cl. A61G 5/10; A61G 5/02; A47C 1/00; A61G 5/00

(52) U.S. Cl. 297/325

(57) ABSTRACT

Disclosed is a reclining adjustment device to control the reclining angle of a tiltable seat frame of a manual wheelchair. The device in accordance with the teachings of this invention includes a guiding mechanism for adjusting the reclining angle of the seat frame to a desired angle selectable from a fixed number of angles between a fully reclined position and a fully upright position, an engaging mechanism releasably engaging the guiding mechanism when the reclining angle of the seat frame is at the desired angle to fix the guiding mechanism in place, a locking mechanism for locking the engaging mechanism to the guiding mechanism at the desired angle, an actuating mechanism, wherein upon actuation of the actuating mechanism, the engaging mechanism is released from the guiding mechanism to permit the guiding mechanism to be adjusted to the desired angle. Preferably the guiding mechanism is a stepped shaft, the engaging mechanism is a slider with three ball bearings positioned equally spaced relative to one another along the stepped shaft, and the locking mechanism is a lock cylinder.

### FIELD OF THE INVENTION

The present invention relates to manual wheelchairs with tiltable seat frames. More specifically, the present invention relates to a lockable reclining adjustment device to control the tilting of the seat frame of a manual wheelchair.

### BACKGROUND OF THE INVENTION

It is common knowledge that wheelchairs are used by patients of varying degrees of paralysis. However, when patients are confined to a wheelchair for prolonged periods of time, pressure sores can appear on the buttock area of the patient. As a result, different types of reclining wheelchairs have been known in the art, that is, wheelchairs which have a reclining back. Such wheelchairs improve the comfort level of patients.

The safety of these wheelchairs with reclining or tilting back rests is an issue. Many of such wheelchairs have an all too high failure rate.

In U.S. Pat. No. 5,195,803 entitled “Reclining Seat Back Assembly for a Wheelchair”, the actuation of levers 104 compresses springs 90 which separates surface 84 from inner strut 66. Then frame member 36 can be pivoted to desired angle as inner strut 66 slides within outer strut 64. The release of 104 locks the position. There appears to be only one side of contact of the engaging member 84 and threaded shaft item 66.

In U.S. Pat. No. 4,544,200 entitled “Wheelchair with Rocking Seat and Reclining Back Features” the position is locked via teeth 152/154 in tracks 82/84. Actuation of lever 158 releases the lock so that the tracks can slide along track guides 86/88 to reposition the seat assembly and back. Release of the lever locks the teeth in a new position. There is a bar in the front of the chair which is controlled by the patient. This device is locked in place via teeth 152/154 in tracks 82/84.

In U.S. Pat. No. 4,487,453 entitled “Seat Recliner Adjustment Mechanism”, there is a locking mechanism 38 engaged with rack member 32. Upward movement of release arm 54 causes spring 64 to disengage the locking mechanism from the rack member so the seat can be re-positioned. This device uses a rod as an actuating means.

The device of U.S. Pat. No. 3,881,773 entitled “Reclining Back Wheelchair” uses a telescoping adjustable tube 21 having a number of slots. Actuation of handles release pawl 32 from the respective slot via a spring loaded bell crank assembly. When the pawl is released the tube is repositioned and the handle released to move the pawl into another slot. This mechanism relies on handle grip 35, bell crank type bracket member 28 and release pawl 32 to allow the adjustable tube to be repositioned.

The device of U.S. Pat. No. 6,921,134 entitled “Apparatus for adjusting inclination of chair backs” uses many latch grooves item 22 on a positioning member 21. This device is complex and has many parts that work with one another.

The device of U.S. Pat. No. 6,267,443 entitled “Reclining seat for vehicle” uses a cam groove where rolling element 23 are positioned and retained by item 24. Release the rolling elements from the grooves allow the use to recline back. In the locked position the rolling elements fit in the groove. This patent uses radial movement to release the rolling elements from their position. The reference patent uses a cam groove, a fixed ring and rotary ring and is enclosed in a casing with many parts and sub components.

One device used to control the reclining action of a wheelchair already having a reclining back rest known in the art is a mechanical linear locking device which is retrofitted on such a wheelchair. Examples can be found at http://www.portergroupllc.com/solutions/mechlokhl.asp and http://www.craneae.com/Solutions/Cabin/mechlok.htm. The device has infinite positions where device can be locked along a shaft.

### SUMMARY OF THE INVENTION

Disclosed is a reclining adjustment device to control the tilting of the seat frame of a manual wheelchair. In accordance with the teachings of this invention, the device is an ‘all in one’ assembly that includes an engaging means, guide means and locking means. The device in accordance with this invention has less moving parts compared to prior devices and a majority of its parts are confined between two locknuts on a shaft. The device in accordance with the teachings of this invention uses a simple mechanism that allows the recline angle of a wheelchair to be adjusted. The device in accordance with the teachings of this invention is smooth and small and does not interfere with the occupant or attendant.

Broadly speaking, there is provided a reclining adjustment device to control the reclining angle of a tiltable seat frame of a manual wheelchair, the device comprising a guiding mechanism for adjusting the reclining angle of the seat to a desired angle selectable from a fixed number of angles between a fully reclined position and a fully upright position; an engaging mechanism releasably engaging the guiding mechanism when the reclining angle of the seat frame is at the desired angle to fix the guiding mechanism in place; a locking mechanism for locking the engaging mechanism to the guiding mechanism at the desired angle; and an actuating mechanism, wherein upon actuation of the actuating mechanism, the engaging mechanism is released from the guiding mechanism to permit the guiding mechanism to be adjusted to the desired angle.

In one embodiment, the engaging mechanism comprises a slider with three ball bearings. Preferably, the three ball bearings are equally spaced around the stepped shaft.

In one embodiment, the guiding mechanism comprises a stepped shaft, the steps on the shaft each defining one of the fixed number of angles. Preferably, the fixed number of angles is 25.

In one embodiment, the locking mechanism comprises a lock cylinder. Preferably, the lock cylinder has holes for mounting the device to an existing wheelchair. In one embodiment, when the device is mounted to an existing wheelchair, the device is mounted between the frames of the wheelchair.

In one embodiment, the actuating mechanism comprises a handle controlling a cable assembly. Preferably, the cable assembly is controlled via a spring, which is preferably a compression spring. In one specific embodiment, the device in accordance with the teachings of this invention uses a cable assembly and lever to control the position of the slider assembly on the stepped shaft and engagement of the ball bearings. This is done by the attendant from the back side usually. In this way, in the event that case something drastic happens, at least the attendant can help the patient.

In one embodiment, a ball end of the cable is placed between a cable holder of the cable assembly and the lock cylinder. Preferably, the handle is located at the back of the wheelchair.

In one embodiment, the engaging mechanism and locking mechanism are located between two lock nuts on the guiding mechanism. This makes the device compact.

Preferably the parts that comprise the device in accordance with the teachings of this invention are either stainless steel or chrome plated which allows better durability and longevity over the long run.

Other aspects and advantages of embodiments of the invention will be readily apparent to those ordinarily skilled in the art upon a review of the following description.

### BRIEF DESCRIPTION OF THE DRAWINGS

Embodiments of the invention will now be described in conjunction with the accompanying drawings, wherein:

FIG. 1a is a perspective view of a typical manual wheelchair frame with a tiltable seat frame;

FIG. 1b is a side view of the wheelchair frame of FIG. 1a;

FIG. 2a is a perspective view of the wheelchair frame of FIG. 1a, incorporating a device in acordance with the teachings of the present invention;

FIG. 2b is a side view of the wheelchair frame of FIG. 2a;

FIG. 3 illustrates a portion of a device in accordance with the teachings of the present invention, excluding the actuating mechanism;

FIG. 4 illustrates an exploded view of the device of FIG. 3;

FIG. 5 illustrates a complete device in accordance with the teachings of this invention; and

FIG. 6 illustrates parts of a cable assembly that can be used in conjunction with a device in accordance with the teachings of this invention. This figure is Detail A of FIG. 5.

This invention will now be described in detail with respect to certain specific representative embodiments thereof, the materials, apparatus and process steps being understood as examples that are intended to be illustrative only. In particular, the invention is not intended to be limited to the methods, materials, conditions, process parameters, apparatus and the like specifically recited herein.

### DETAILED DESCRIPTION OF THE DISCLOSED EMBODIMENTS

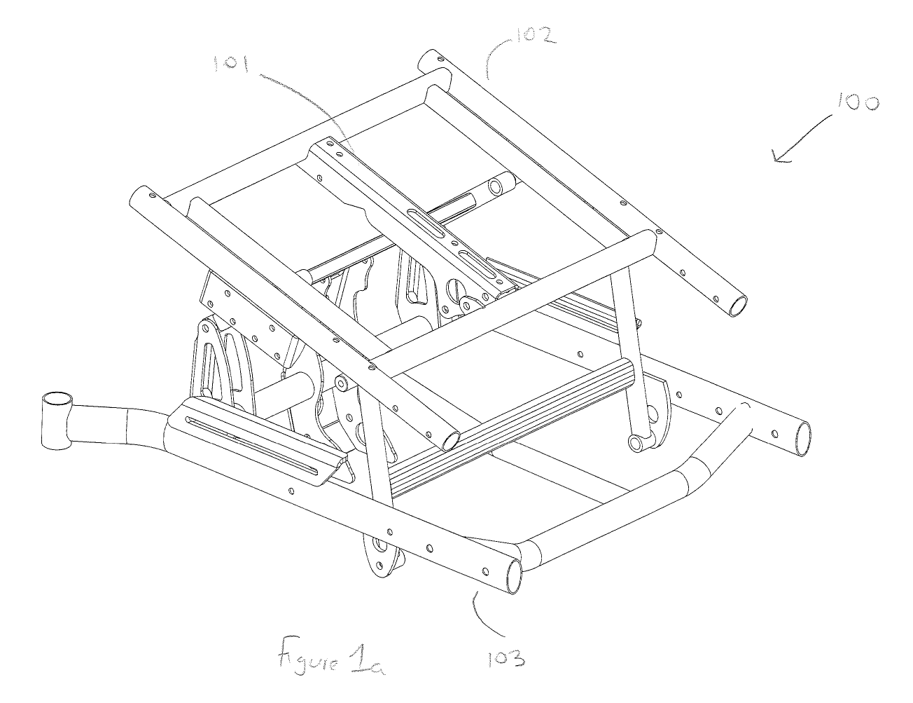

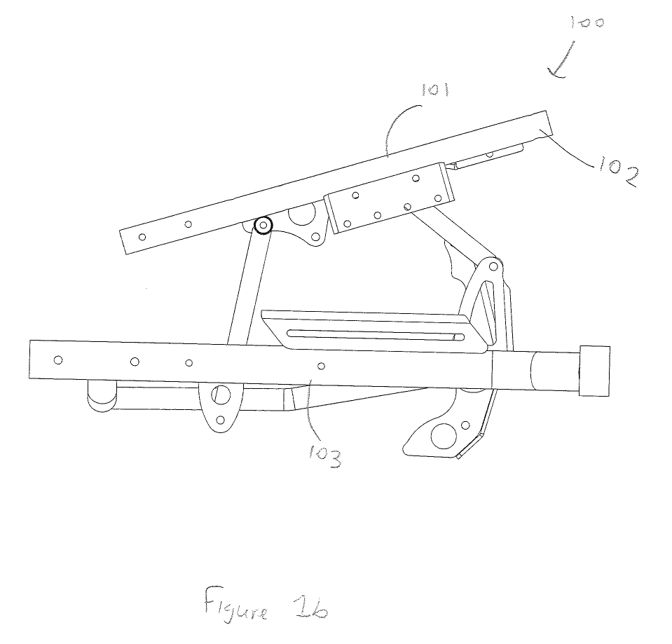

Referring to FIGS. 1a and 1b, there is shown a typical manual wheelchair frame 100 with a tiltable seat frame 101. Manual wheelchairs are hand-operated. This is in contrast to power or electric wheelchairs that are motorized. Since power or electric wheelchairs use linear actuators with built-in brakes to drive the tilt and recline features, there is no need for an additional locking device, such as a device in accordance with the teachings of this invention. It is assumed that such a wheelchair frame 100 is readily understood by those skilled in the art, so will be discussed only briefly.

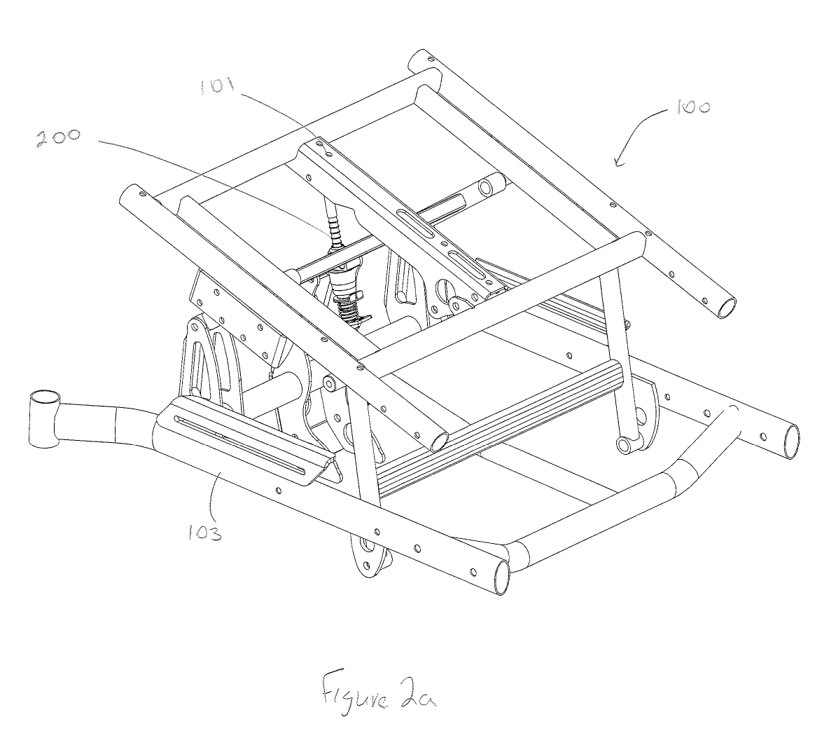

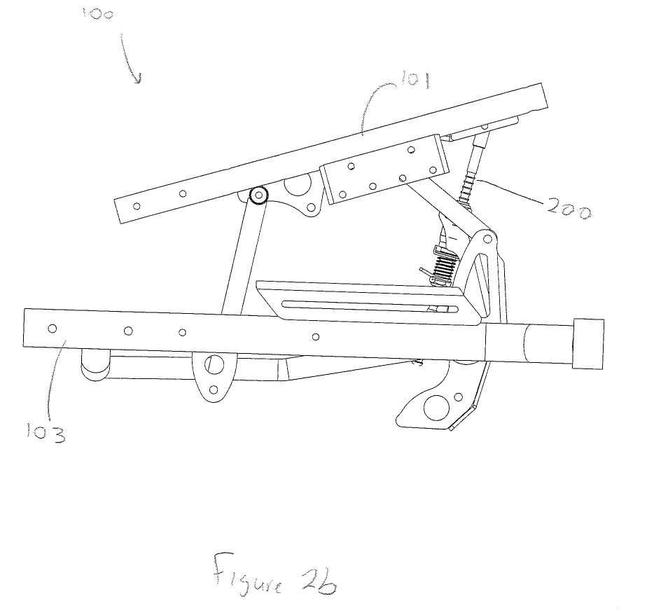

Such a typical wheelchair frame 100 comprises an upper chair frame 102 and a lower chair frame 103. The upper chair frame 102 typically includes a seat frame 101 supporting a seat 105, and a back rest, leg rest, arm rests, head rest, and/or a foot rest. The lower chair frame supports wheel assemblies 111. As can be seen, the wheelchair frame 100 described above is a standard, conventional wheelchair frame known by those skilled in the art. The present invention is directed to an additional device which is added to the above-described wheelchair or during the manufacture of new wheelchairs to achieve a new and advantageous result. Such a wheelchair is illustrated in FIGS. 2a and 2b.

A reclining mechanism 200 is used to selectively position the seat frame 101 of the wheelchair frame 100 with respect to the lower chair frame 103. Generally, the seat frame 101 can be positioned between a plurality of positions varying from a fully upright position, where the seat frame 101 is vertical to a fully reclining position where seat frame 101 is fully horizontal.

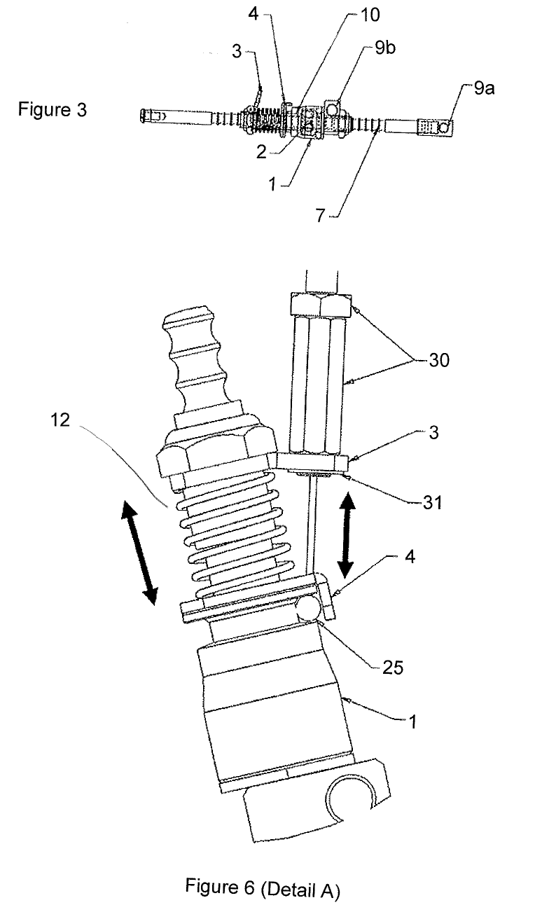

Referring to FIGS. 3, 4 and 5, broadly, the device 200 in accordance with the teachings of this invention is a reclining adjustment device to control the reclining angle of a tiltable seat frame 101 of a manual wheelchair. In broad terms, the device 200 comprises a guiding mechanism for adjusting the reclining angle of the seat frame to a desired angle selectable from a fixed number of angles between a fully reclined position and a fully upright position; an engaging mechanism releasably engaging the guiding mechanism when the reclining angle of the seat frame is at the desired angle to fix the guiding mechanism in place; a locking mechanism for locking the engaging mechanism to the guiding mechanism at the desired angle; and an actuating mechanism, wherein upon actuation of the actuating mechanism, the engaging mechanism is released from the guiding mechanism to permit the guiding mechanism to be adjusted to the desired angle.

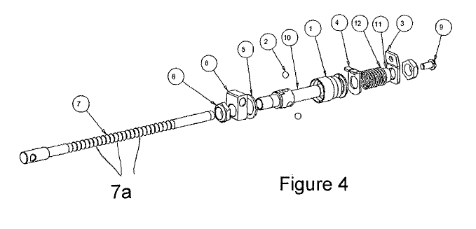

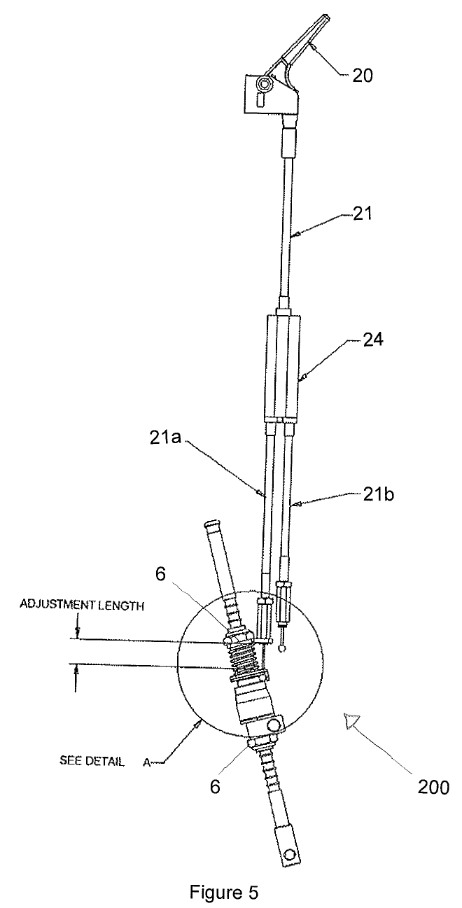

As illustrated, the engaging mechanism comprises a slider 10 with three ball bearings 2 (only one ball bearing is seen in FIGS. 3 and 5, and two ball bearing are seen in FIG. 4). By using three ball bearings 2 for engagement, in the event that one ball bearing fails, the other ball bearings can function to still help to operate the device properly. By using three ball bearings, the reclining adjustment device uses radial movement rather than linear movement for control. The ball bearing is preferably ¼″ chrome. By using ball bearings over, for example, a teethed rack the index positions can be closer together giving more precision.

As mentioned above, the three ball bearings 2 are equally spaced relative to one another along the stepped shaft. Thus, the device 200 has three sides of contact, allowing the device 200 to have a better ‘hold’ than previously has been available. The device is designed to keep the center to center distance of the ball bearings at a minimum, which provides smaller increments of adjustment. The greater the number of indexes over a distance, the better the precision.

The guiding mechanism comprises a stepped shaft 7, wherein recessed steps are provided in the shaft for the ball bearings to rest in. The steps 7a on the shaft 7 each defining one of the fixed number of angles. Preferably, the fixed number of angles is 25 over a travel distance of 5.68″. The deeper the steps in the shaft, the better the holding power of the ball bearings, but the center distance then increases. Preferably, the center distance is 0.22″.

The locking mechanism comprises a lock cylinder 1. The device 200 uses a lock collar or cylinder 1 to lock the ball bearings 2 in place along the stepped shaft 7. As illustrated, the lock cylinder 1 has holes 1a for mounting the device 200 to an existing wheelchair, as is described in detail below.

The actuating mechanism comprises a handle 20 controlling a cable assembly comprising cable bracket 3 and cable holder 4. A cable 21 goes through splitter box 24 and is split into a lower long cable 21a and lower short cable 21b are flexible and can be placed in a convenient location for the attendant. The lower long cable 21a is connected to the device via lower adapter lock nuts 30 and a 7/32 retaining ring 31. The lower short cable 21b is connected to a gas cylinder (not shown) for operation. The device uses a cable assembly and lever 20 to control the position of the slider assembly 10 on the stepped shaft 7 and engagement of the ball bearings. This is done by the attendant from the back side usually, as described in detail below. In this way, in the event that something drastic happens during operation, at least the attendant can help the patent.

As illustrated, the cable assembly is controlled via a spring 12, which is preferably, a compression spring. The cable holder 4 and lock collar 1 are shaped to allow the ball end 25 of the steel cable 21 (used for actuating) to be permanently in place between these parts so that the device 200 functions properly. The lock collar uses an angle bracket to guide the cable to the side since it is blocked from coming through the center because of the shaft. The inventor has discovered that the optimal angle is 45°; if the angle is higher, the pull force is decreased and if the angle is less than 45°, the bracket will interfere with the seat frame positioning.

Preferably, the size of steel wire should be 16 ga (0.06) diameter. Preferably, the size of ball end should be 3/16″ diameter.

Preferably, the handle 20 is located at the back of the wheelchair. As will be discussed in detail below, in operation the device uses axial movement to release the ball bearings 2 from their position. The spring 12 is compressed and causes the lock collar 1 to move away from the ball bearings 2 because of spacer 11. The bearings 2 then come out of the contact with the stepped shaft 7 and the position of the mechanism can be changed.

The engaging mechanism and locking mechanism are located between two lock nuts 6 on the guiding mechanism. Optionally, there may be a dust and duct protector 5.

As can been seen and understood by the foregoing, the device 200 in accordance with the teachings of this invention is engineered in a manner that all of the components needed to engage, guide and lock the mechanism are located near one another. Thus the device can easily be replaced and through the use of wrenches taken apait and easily troubleshoot.

The device 200 in accordance with the teachings of this invention can be made from any suitable material such as metal, plastics, or synthetic resins which have the necessary characteristics, such strength to function suitably. Aluminum or other light-weight metals are used to help in controlling the overall weight of the wheelchair. Preferably, the device is stainless steel or chrome plated.

The maximum load on the tilting object is typically less than about 250 lbs. It will be understood by those skilled in the art that other design criteria must be considered in using a device in accordance with the teachings of this invention on a wheelchair. For example, the stroke length and holding force required must be suitable for use on wheelchairs.

Operation

To tilt the seat frame 101, when the user pulls the handle 20, the cable holder 4 moves down and compresses the spring 12. The space caused by the compression of the spring 12 allows the lock cylinder 1 to move away from the ball bearings 2. The ball bearings 2 are then released from the stepped shaft 7 and the shaft 7 is ‘free’ to move up or down. The patient can change the tilt angle of the object by moving the stepped shaft 7 up or down. Grease is used to allow the slider assembly 10 to move along the stepped shaft 7 in a smooth manner and also reduces the friction between the ball bearings 2 and stepped shaft 7 when the device is ‘locked’. Once the appropriate tilt angle is set the patient releases the handle 20 and the spring 12 expands 10 cause the lock cylinder 7 to move towards the ball bearings 2. The ball bearings 2 are then placed in contact with the stepped shaft 7 and the shaft 7 is fixed in place. The lock cylinder 1 covers the ball bearings 2 and ‘locks’ the complete mechanism in place along the stepped shaft 7. The complete process allows the tilting object to move to a new position-either away from the fixed object or towards the fixed object.

Mounting

To mount the device 200 in accordance with the teachings of this invention, one has to secure the device 200 to the tilting object by fastening a ¼-20 bolt (not shown) through hole 9a located at the end of the stepped shaft. The device also has to be secured to the fixed object by fastening a 5/16-18 bolt (not shown) through hole 9b located on the pivot block 8. In order to connect the device 200 to handles 20 for proper operation a steel cable 21 needs to be used that preferable has a ball end that can be fastened to the cable holder 4 as shown in FIG. 6 (detail A of FIG. 5). When the device 200 is mounted to an existing wheelchair, the device 200 is mounted between the upper and lower frames of the wheelchair. Numerous modifications may be made without departing from the spirit and scope of the invention as defined in the appended claims.

What is claimed is:

1. A reclining adjustment device to control the reclining angle of a tiltable seat frame of a manual wheelchair, the device comprising:
a stepped shaft for adjusting the reclining angle of the seat frame to a desired angle selectable from a fixed number of angles between a fully reclined position and a fully upright position, the steps on the shaft each defining one of the fixed number of angles;
a slider with three ball bearings positioned equally spaced relative to one another along the stepped shaft for releasably engaging the stepped shaft when the reclining angle of the seat frame is at the desired angle to fix the stepped shaft in place;
a lock cylinder locking the ball bearings to the stepped shaft at the desired angle; and
an actuating mechanism, wherein upon actuation of the actuating mechanism, the ball bearings are released from the stepped shaft to permit the stepped shaft to be adjusted to the desired angle.

2. The device of claim 1, wherein the fixed number of angles is 25.

3. The device of claim 1, wherein the actuating mechanism comprises a handle controlling a cable assembly.

4. The device of claim 3, wherein the cable assembly is controlled via a spring.

5. The device of claim 4, wherein the spring is a compression spring.

6. The device of claim 4, wherein a ball end of the cable is placed between a cable holder of the cable assembly and the lock cylinder.

7. The device of claim 3, wherein the handle is located at the back of the wheelchair.

8. The device of claim 1, wherein the slider with three ball bearings and lock cylinder are located between two lock nuts on the stepped shaft.

9. The device of claim 1, wherein when the device is mounted to an existing wheelchair, the device is mounted between the frames of the wheelchair.

10. The device of claim 1, wherein the device is stainless steel or chrome plated.

11. A reclining adjustment device to control the reclining angle of a tiltable seat frame of a manual wheelchair, the device comprising:
a guiding mechanism for adjusting the reclining angle of the seat frame to a desired angle selectable from a fixed number of angles between a fully reclined position and a fully upright position;
an engaging mechanism releasably engaging the guiding mechanism when the reclining angle of the seat frame is at the desired angle to fix the guiding mechanism in place;
a locking mechanism for locking the engaging mechanism to the guiding mechanism at the desired angle; and
an actuating mechanism, wherein upon actuation of the actuating mechanism, the engaging mechanism is released from the guiding mechanism to permit the guiding mechanism to be adjusted to the desired angle.

12. The device of claim 11, wherein the engaging mechanism comprises a slider with three ball bearings.

13. The device of claim 12, wherein the three ball bearings are positioned equally spaced relative to one another along the guiding mechanism.

14. The device of claim 11, wherein the guiding mechanism comprises a stepped shaft, the steps on the shaft each defining one of the fixed number of angles.

15. The device of claim 14, wherein the fixed number of angles is 25.

16. The device of claim 11, wherein the locking mechanism comprises a lock cylinder.

17. The device of claim 11, wherein the actuating mechanism comprises a handle controlling a cable assembly.

18. The device of claim 17, wherein the cable assembly is controlled via a spring.

19. The device of claim 18, wherein a ball end of the cable is placed between a cable holder of the cable assembly and the lock cylinder.
